(19) United States
(12) Patent Application Publication
(10) Pub. No.: US 2009/0004467 A1
(43) Pub. Date: Jan. 1, 2009

(54) HIGH DURABILITY CONTACTLESS IDENTIFICATION CARD

(75) Inventor: Felix P. Shvartsman, New Haven, CT (US)

Correspondence Address: SHERIDAN ROSS PC, 1560 BROADWAY, SUITE 1200, DENVER, CO, 80202, US

(73) Assignee: ASSA ABLOY AB, Stockholm (SE)

(21) Appl. No.: 12/206,555

(22) Filed: Sep. 8, 2008

Related U.S. Application Data
(63) Continuation-in-part of application No. 11/668,094, filed on Jan. 29, 2007.
(60) Provisional application No. 60/789,962, filed on Apr. 5, 2006.

(51) Int. Cl. B32B 27/28; B32B 37/00

(52) U.S. Cl. 428/339; 428/412; 156/60

(57) ABSTRACT

A 10-year universal contactless composite card is provided that can be personalized by both color and black&white surface printing and laser-engraving. The card includes a prelam layer or core that is a combination of polyvinyl chloride and polycarbonate. A co-extruded polycarbonate layer is then provided external to the polyvinyl chloride/polycarbonate core. The co-extruded polycarbonate layer is capable of being engraved by a laser. A clear polyvinyl chloride layer, which is capable of accepting printing ink, may then be provided on top of the co-extruded polycarbonate layer, thereby allowing the card to be personalized with either printing techniques or laser-engraving techniques.

### CROSS REFERENCE TO RELATED APPLICATIONS

This application is a Continuation-in-Part of U.S. patent application Ser. No. 11/668,094, filed Jan. 29, 2007, which claims the benefit of U.S. Provisional Application No. 60/789,962, filed Apr. 5, 2006, the entire disclosures of which are hereby incorporated herein by reference.

### FIELD OF THE INVENTION

The present invention is directed toward identification cards. More specifically, methods and systems of producing and materials used to produce such a card are provided herein.

### BACKGROUND

Polyvinyl chloride (PVC) is used in the production of contactless proximity identification cards because it has the ability to melt and flow under heat and pressure during the card lamination process. This property of PVC allows most internal electronic parts of the proximity card, such as various antennas and chips, to be hid relatively well. However, PVC does not offer adequate durability even under the normal use conditions. Often, PVC cards fail due to fatigue or plasticizer attach, which causes severe cracking of the cards. In more aggressive-use applications, such as proximity ID badges, the low structural rigidity durability of PVC cards becomes even more apparent.

Another deficiency of PVC-based proximity cards is that even limited exposure of the cards to heat causes the cards to warp beyond ISO specifications due to the stress introduced into the card by the embedded antenna coil. Introduction of polyethylene terephtalate (PET) films in the laminated plastic card structure is known to significantly improve a card's dimensional stability, as well as reduce cracking and enhance the card's resistance to plasticizer attack.

PET/PVC composite cards are widely used today in the identification card market as durable plastic cards in applications such as access control badges, driver's licenses, and sometimes in National ID cards. Most National ID card programs have a default requirement that personalization of the card be possible so that the card holder can be identified by some sort of printing provided on the hard. However, composite PET/PVC cards have important security personalization limitations since they cannot be laser-engraved. Also, PET/PVC cards have certain structural deficiencies because PET is not an amorphous polymer. In spite of being a bi-axially oriented polymer, certain stress is induced in the PET film during its manufacture. Therefore, when laminated PET/PVC cards, and especially contactless cards with antennas and chips located asymmetrically inside the cards, are subject to elevated temperatures, they are prone to warping and torque that make them deviate from ISO specifications for card flatness.

Structural deficiency of PET/PVC cards has been improved recently with the introduction of Polycarbonate (PC) cards. These PC cards are also laser-engraveable. PC-based cards are being used today in National ID programs due to their durability and ability to be laser engraved. Such PC cards are being laminated at very high temperatures and pressure and, therefore, do not have a clear-PVC overlay on its surface. Clear-PVC overlay layers are required in many applications to support digital printing personalization techniques (e.g., printing a person's picture on the surface of the card). In addition to this shortcoming, pure PC cards are somewhat brittle and when they are subjected to a certain amount of bending during use, they can crack or become otherwise unusable. These shortcomings make them a poor candidate for 10-year cards (i.e., cards that are designed to withstand 10 years of normal use and still comply with ISO specifications) that are required for certain National ID programs.

### SUMMARY

To address these and other needs of the prior art, a true 10-year universal contactless PC/PVC composite card is provided, which can be personalized by both color surface printing and laser-engraving. None of the existing high durability card constructions are capable of being universally personalized by both surface printing and laser-engraving. Embodiments of the present invention provide a new PVC/PC card that is a true composite-type laminate. The card prelam or core can be made of PVC/PC/PVC alternating layers that hide interior electronics (e.g., antennas and chips) of the contactless cards significantly better than existing technologies and thereby improves the cosmetics of the finished card. Furthermore, the costs of producing such a card are relatively lower than the costs associated with producing a pure PC-based card.

In accordance with at least one embodiment of the present invention, a data carrying device is provided that generally comprises:

a prelam comprising adapted to receive electronic components;

a first layer provided on a first side of the prelam; and

a second layer provided on a second side of the prelam, wherein at least one of the first and second layers are a co-extruded Polycarbonate (PC) material.

In accordance with at least some embodiments of the present invention, the co-extruded PC material may be laser engraveable such that the data carrying device can be personalized. Furthermore, a printable layer is provided on the engraveable layers such that the card can be personalized by either ink-based printing or laser-engraving.

In accordance with at least some embodiments of the present invention, a method of producing a data carrying device is provided that comprises:

providing a prelam, wherein the prelam is adapted to receive electronic components;

placing an engraveable first layer on a first side of the prelam; and

placing an engraveable second layer on a second side of the prelam.

These and other advantages will be apparent from the disclosure of the invention(s) contained herein. The above-described embodiments and configurations are neither complete nor exhaustive. As will be appreciated, other embodiments of the invention are possible using, alone or in combination, one or more of the features set forth above or described in detail below.

### BRIEF DESCRIPTION OF THE DRAWINGS

FIG. 1 depicts a cross-sectional view of a data carrying device core in accordance with at least some embodiments of the present invention; and

FIG. 2 depicts a cross-sectional view of a data carrying device in accordance with at least some embodiments of the present invention;

### DETAILED DESCRIPTION

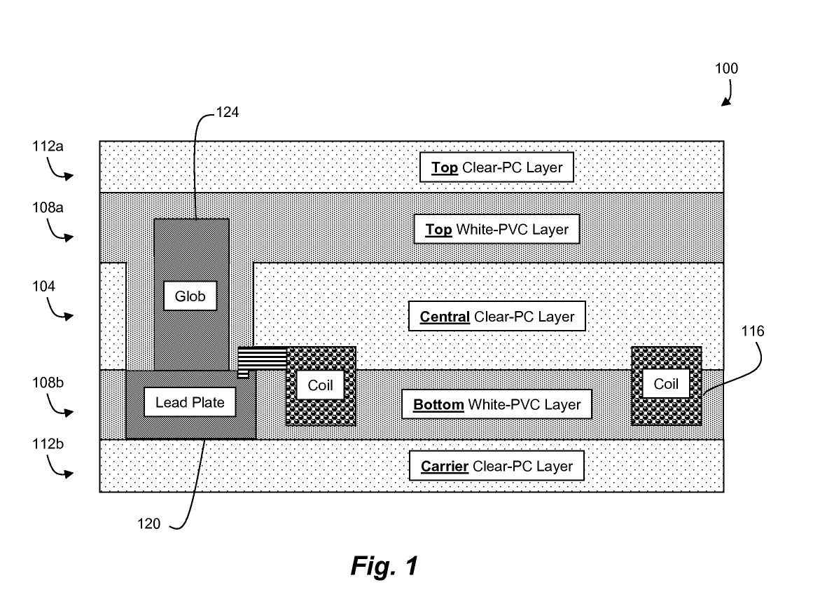

Referring initially to FIG. 1, an exemplary prelam 100 for a card will be described in accordance with at least some embodiments of the present invention. The prelam 100 may also be referred to as a card core or internal layers of the card. The prelam 100 is traditionally used to encapsulate the electronic components of the card such as the card's antenna 116 and Integrated Circuit (IC) which may include a lead plate 120 on which circuit elements are mounted and/or a glob top 124 used to protect the circuit elements of the IC. As can be seen in FIG. 1, the electronic components may have a thickness greater than the thickness of a certain layer and, therefore, may traverse multiple layers of the prelam 100.

In accordance with at least some embodiments of the present invention, the prelam 100 may comprise 3 or 5 layers of material. In the depicted embodiment, the prelam 100 comprises 5 layers, which include a middle or central layer 104, two intermediate layers 108a, 108b, and two external prelam layers 112a, 112b. The middle layer 104 is, in accordance with one embodiment of the present invention, a clear PC layer and may have a thickness of about 175 μm (7 mil). The intermediate layers 108a, 108b that are provided on opposite side of the middle layer 104 may be made of white PVC and may have a thickness of about 100 μm (4 mil) each. The external prelam layers 112a, 112b may also be constructed of a clear PC and may have a thickness of about 75 μm (3 mil).

In accordance with at least some embodiments of the present invention, the intermediate layers 108a, 108b may alternatively be constructed of white Polyethylene terephtalate Glycol (PETG). Such a construction may be useful if a non-PVC card construction is specified by a prospective consumer of the card.

As can be appreciated by one skilled in the art, the thickness of each layer in the prelam 100 may be adjusted to accommodate the thickness of the IC 120, 124 being used. In accordance with one embodiment of the present invention, the prelam 100 may have a total thickness of about 500 μm (20 mil). As an example, the glob 124 and lead plate 120 may have a combined thickness of between about 320-400 μm (13-16 mil). The prelam 100 may have a pre-lamination thickness of between about 425-500 μm (17-20 mil) and a post-lamination thickness of between about 375-450 μm (15-18 mil). Thus, the glob 124 and lead plate 130 may span the middle layer 104 and both intermediate layers 108. In accordance with at least some embodiments of the present invention, the middle PC layer 104 and both intermediate layers 108 may have a die-cut hole aligned to receive the glob 124 and lead plate 120.

Further details of the construction of such a prelam 100 and possible alternative configurations are described in U.S. patent application Ser. No. 11/668,094, to Shvartsman, the entire contents of which are hereby incorporated herein by reference.

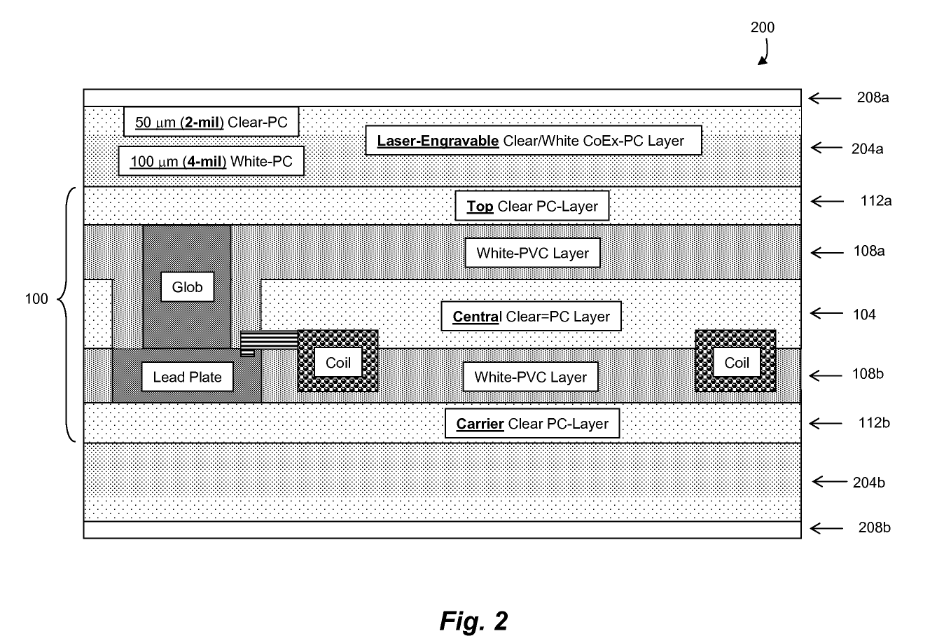

As can be seen in FIG. 2, a card 200 may be constructed utilizing the prelam 100. Such a card may be able to withstand over 10 years of normal wear and use in relatively aggressive-use applications without warping beyond ISO standards. In accordance with at least one embodiment of the present invention, a card 200 may be constructed with the prelam 100 as its core, two engraveable layers 204a, 204b provided on each side of the prelam 100, and two printable layers 208a, 208b on the outside of each engraveable layer 204a, 204b, respectively.

The engraveable layers 204a, 204b may be laser engraveable. More specifically, the engraveable layers 204a, 204b may be capable of being etched with a laser with personalized information related to the ultimate user of the card 200. In accordance with at least one embodiment of the present invention, the engraveable layers 204a and/or 204b may comprise a co-extruded PC printing core such as Markofol® ID produced by Bayer MaterialScience AG in Leverkusen, Germany. This engraveable layer 204a, 204b may have a total thickness of about 150 μm (6 mil). The co-extruded PC layer 204 may be a composite of two different portions of PC. For example, the PC layer 204 may have a portion that is clear PC and another portion that is white PC. The white PC portion of the PC layer 204 may be the portion that is laser engraveable and this portion may be located facing the prelam 100. In accordance with at least one embodiment of the present invention, 50 μm (2 mil) of the PC layer's 204 total thickness is the clear PC portion and 100 μm (4 mil) of the PC layer's 204 total thickness is the white PC portion.

The printable layers 208a, 208b may be adhesive coated to ensure that a quality bond is made with the engraveable layers 204a, 204b, respectively. More particularly, and in accordance with at least one embodiment of the present invention, the printable layers 208a, 208b may comprise a clear PVC overlay that is adhesive coated and has a thickness of about 50 μm (2 mil). Also, to further ensure quality construction of the card 200, the prelam 100 may be coated with an adhesive to create an enhanced bond between the prelam 100 and each engraveable layer 204a, 204b.

Composite cards 200 may be produced in accordance with at least some embodiments of the present invention by utilizing standard lamination techniques at a maximum lamination temperature of about 135° C. Certain layers of the card 200 may be die-cut to receive the glob 124 and lead plate 120 and the coil 116 may be initially formed separately and placed on a layer in the prelam 100 or may be formed on a layer (e.g., the middle layer 104) of the prelam 100. Cards 200 produced in accordance with at least some embodiments of the present invention may be personalized utilizing, for example, Die-Diffusion Thermal-Transfer (D2T2) printing with a Fargo® HDP-5000 card printer produced by Fargo Electronics of HID Global Corporation in Eden Prairie, MN. The personalized card 200 may be topcoated with a polyester protective film to ensure that the ink printed on the printable layer 208a and/or 208b does not smear. Such cards 200 may be able to resist warping upon completion of the card personalization procedure (i.e., engraving and printing). These cards 200 can be qualified at 10-year cards in accordance with the requirements of the new ANSI-INCITS and ISO Card Service Life Standards.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A laminated data carrying device, comprising:
a prelam adapted to receive electronic components;
a first layer provided on a first side of the prelam; and
a second layer provided on a second side of the prelam, wherein at least one of the first and second layers are a co-extruded polycarbonate material.

2. The device of claim 1, wherein at least one of the first and second layers are laser engraveable.

3. The device of claim 1, wherein the co-extruded polycarbonate material comprises a clear polycarbonate portion and a white polycarbonate portion.

4. The device of claim 1, wherein a middle layer of the prelam comprises polycarbonate, wherein two intermediate layers of the prelam provided on each side of the middle layer comprise polyvinyl chloride, and wherein external layers provided on each side of the intermediate layers comprise polycarbonate.

5. The device of claim 1, further comprising:
a third layer provided proximate to the first layer opposite to the prelam; and
a fourth layer provided proximate to the second layer opposite to the prelam.

6. The device of claim 5, wherein at least one of the third and fourth layers are printable by utilizing at least one of color and black-and-white card surface printing technologies.

7. The device of claim 5, wherein at least one of the third and fourth layers comprise a clear overlay.

8. The device of claim 1, wherein the first and second layers each comprise a thickness of about 150 μm.

9. The device of claim 1, wherein an adhesive is provided between the prelam and the first and second layers.

10. The device of claim 1, wherein the prelam is laminated prior to having the first and second layers being placed proximate to the prelam.

11. A method of manufacturing at least one data carrying device, comprising:
providing a prelam, wherein the prelam is adapted to receive electronic components;
placing a laser engraveable first layer on a first side of the prelam; and
placing a laser engraveable second layer on a second side of the prelam.

12. The method of claim 11, wherein the first layer comprises a co-extruded polycarbonate layer and the second layer comprises a co-extruded polycarbonate layer.

13. The method of claim 11, further comprising, prior to placing the first and second layers on the first and second sides of the prelam, laminating the prelam.

14. The method of claim 11, wherein the first layer comprises a clear polycarbonate portion and a white polycarbonate portion.

15. The method of claim 11, wherein a middle layer of the prelam comprises polycarbonate, wherein two intermediate layers of the prelam provided on each side of the middle layer comprise polyvinyl chloride, and wherein external layers provided on each side of the intermediate layers comprise polycarbonate.

16. The method of claim 11, further comprising:
placing a third layer proximate to the first layer opposite to the prelam; and
placing a fourth layer proximate to the second layer opposite to the prelam.

17. The method of claim 15, wherein at least one of the third and fourth layers are printable by utilizing at least one of color and black-and-white card surface printing technologies.

18. The method of claim 15, wherein at least one of the third and fourth layers comprise a clear overlay and have a thickness of about 50 μm.

19. The method of claim 15, wherein an adhesive is provided between the prelam and the first and second layers.

20. The method of claim 15, wherein an adhesive is provided between the first and second layers and the third and fourth layers.

21. The method of claim 11, wherein the electronic components comprise at least one of an antenna and chip.
